(19) United States
(12) Patent Application Publication
(10) Pub. No.: US 2012/0137226 A1
(43) Pub. Date: May 31, 2012

(54) Educational Support System

(76) Inventors: Julian Jenkins, Oxford, PA (US); Dan Chidester, Downingtown, PA (US)

(21) Appl. No.: 13/286,585

(22) Filed: Nov. 1, 2011

Related U.S. Application Data
(60) Provisional application No. 61/408,704, filed on Nov. 1, 2010.

(51) Int. Cl. G06F 3/048

(52) U.S. Cl. 715/745

(57) ABSTRACT

A system to integrate all aspect to the operation and administration of an educational institution, including customized interfaces for different classes of users, allowing differing levels of access and functionality, including, teachers, parents, students, administrators, secretaries, and school nurses.

### RELATED APPLICATIONS

This application claims the benefit of U.S. provisional application 61/408,704, filed Nov. 1, 2010 and entitled “Educational Support System”.

### BRIEF SUMMARY

This program allows school personnel and parents to communicate and have up to date school wide information. It allows the teacher to differentiate instruction through personal computers which house all student progress and assignments (in school and at home). This program is environmentally friendly because it will considerably cut down on the amount of photocopying that needs to be done on a daily basis. The program allows teachers to keep students actively engaged in learning at a level that meets their needs.

### DESCRIPTION OF THE DRAWINGS

FIG. 1 is a system-level architecture diagram of the system of the present invention.

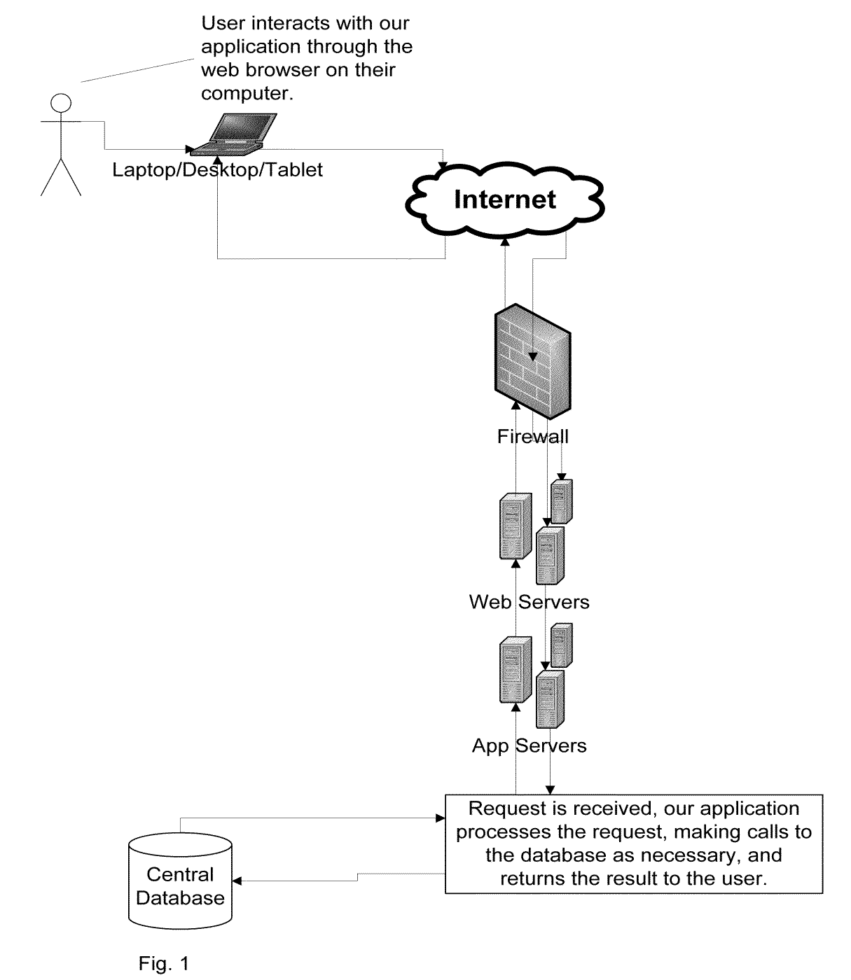

FIG. 2 is a software data flow diagram of the main components of the system

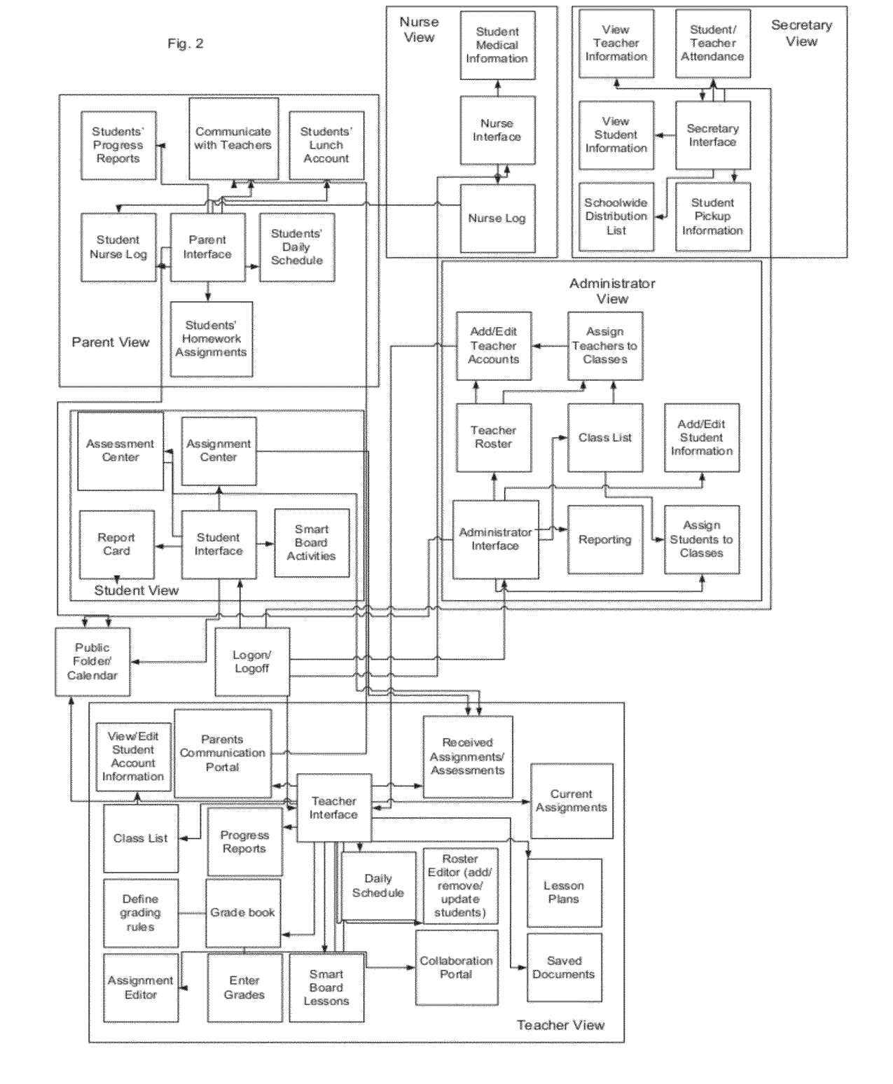

### DETAILED DESCRIPTION

The system of the present invention is a support mechanism to support all aspects of the running and administration of a school, at any level. It includes modules for different types of personnel, including parents, students, teachers, administrators, secretaries, medical staff, etc. This is a brief description of each concept and component in the system.

Grade Book—Grades from assessments and work organized by subject and marking period. All grades of each individual student in every subject area are stored here. The module organizes assessments by subject and date completed.

Communication Portal for Parents—The parents access this facility through a link found on school website that connects homeroom teacher's account to parent's account where parents and teachers can communicate. There is also a link found on school website from school or teacher's account to parent's account that informs parents what is happening school wide or by individual classroom. The school communication portal contains school announcements, updates, educational support web links, weekly lunch menu, amount of money in lunch account, daily class schedule, school wide calendar, daily assignments, school closing and/or delays, homework and student progress reports.

Student Personal Accounts—These are folders organized by subject with assignments and/or assessments with or without grades. Assignments and assessments are completed through a tablet notebook or PC. Tehre is a link to the teacher's account for each subject such that assignments can be handed in or assessments can be entered. There is a capability to interact with Smart Board via personal computer.

Student Progress Reports—This module tracks students' progression throughout the year by class or individual student. The Administrator/Superintendent and teachers will have access to the whole class or individual student. Each individual student's progress report can only be seen by the student or the student's parents.

Teachers' Personal Account—This module includes lesson plans, grade books, a public folder, a private folder, students' progress reports, and a communication portal for the teacher's class and class wide distribution list. Contains updates on which students have completed or have yet to complete an assignment. Allow teachers to interact with students via lessons on the Smart Board, which can be viewed via each student's personal computer

School Wide Distribution List—This module allows parents communication via email to inform them that the communication portal has been updated with new information.

Public Folder—Contains activities and assessments itemized by subject can be saved here so that any other teacher or administrator in the school, district or county can use them.

Private Folder—Contains activities and assessments saved by a teacher for personal classroom use only.

Nurse Account—There is a screen where the nurse can log who came in, the time, and the medical reason. Another screen will send an email to the parent of the child who came to the nurse office informing the parent when and why their child saw the nurse. Another function of the interface is that all medical records for each student are accessible.

Users—The following types of users have been defined for the system

Administrators and Superintendents—Administrators and/or superintendents have access to all grade books, communication portal to parents, teachers' lesson plans, students' personal accounts, students' progress reports, teachers' personal accounts, school wide distribution list and public folder.

Teachers—Teachers have access to their own account which contains their daily lesson plans and daily schedule, students' personal accounts, students' progress reports, parents' communication portal, school wide public folder, personal lesson plans and grade book.

Secretary—Secretaries have access to show daily, quarterly, and yearly attendance.

They can also see each teachers' and students' contact information. The school wide distribution list will also be another feature that the secretaries will have access to. They will also be able to see who is legally allowed to pick up each student.

Students—Students have access to their own personal account.

Nurse—Nurses have access to all students' medical records as well as a daily log of visitations and informative emails to parents.

Parents—Parents have access to the communication portal and their child's progress reports.

Interfaces—This section described the interfaces useable by different types of users of the system

Administrator Interface—The administrator interface component provides the primary interface for the administrator to interact with the system. There is a screen that will allow the administrator to see each class found by grade level or teacher's name. This screen will have links to each teacher's personal account. The teacher's personal account will access the following functions for the administrator: lesson plans, daily schedule, students' personal accounts, students' progress reports, parents' communication portal, school wide public folder, and grade book. The students' personal account screen accessible by the administrator will have these functions: subject folders where assignments or assessments are located with our without grades. Another screen will show grade level progress reports. An additional screen will show the administrator any students who have confidential information.

Teacher Interface—The teacher interface component provides the primary interface for the teacher to interact with the system. There is a screen that will show the teacher the entire class list along with students' contact information. Additional screens are as follows: lesson plans, daily schedule, grade book, public and private folders (saved documents that can be shared with entire school—public or saved just for teacher's use—private), students' progress reports, received assignments or assessments from student interface, communication portal for parents, completed and incomplete assignments/assessments, and Smart Board lessons.

Secretary Interface—The secretary interface component provides the primary interface for the secretary to interact with the system. There is a screen that will show daily, quarterly, and yearly attendance. Another screen will show each teachers' and students' contact information. The school wide distribution list will also be another screen that the secretary will have access to. There is a screen that will allow the secretary to view who is legally allowed to pick up each student.

Nurse Interface—The nurse interface component provides the primary interface for the nurse to interact with the system. There is a screen where the nurse can log who came in, the time, and the medical reason. Another screen will send an email to the parent of the child who came to the nurse's office informing the parent when and why their child saw the nurse. Another function of the interface is that all medical records for each student are accessible to the nurse.

Student Interface—The student interface component provides the primary interface for the student to interact with the system. There is a screen that shows folders organized by subject with assignments and/or assessments. Another screen allows students to complete assignments or assessments and send them to the teacher's interface. The Smart Board activities are another screen for the student.

Parent Interface—The parent interface component provides the primary interface for the parent to interact with the system. There is a screen that shows their child's progress reports. The interface will allow the parent to access these functions:

communicate with the teacher, view school wide calendar, monthly lunch menu, total amount of money in child's lunch account, school announcements, school closing and/or delays, educational support web links, daily class schedule, and class and homework assignments.

We claim:

1. A system for supporting educational institutions, comprising:
one or more computers;
one or more databases, store on permanent storage accessible by said one or more computers;
software, running on said one or more computers for providing access to information stored in said databases, said software providing:
a log-on facility, allowing users to input user names and passwords, and presenting users with an interface customized to the type of user;
a teacher interface, for allowing teachers to enter grades and progress reports for students and to create, edit and post assignments and to receive assignments from students;
a parent interface, allowing parents view progress reports and assignments of their students;
a student interface, allowing students to view grades and progress reports and to view and turn in assignments; and
an administration interface, allowing administrators to add and edit teacher and student information and to assign students and teachers to classes.

2. The system of claim 1 wherein said software further comprises:
a secretary interface allowing secretaries to view student and teacher information and to track student and teacher attendance.

3. The system of claim 1 wherein said software further comprises:
a nurse interface allowing a school nurse to access student medical information and to log medical incidents.

4. The system of claim 1 wherein said parent and teacher interfaces allows communication therebetween.

5. The system of claim 1 wherein said parent interface allows patents to access the daily schedule of their students.

6. The system of claim 1 wherein said parent interface allows patents to access the lunch account of their students.

7. The system of claim 3 wherein said parent interface allows patents to access logs of medical incidents involving their students.

8. The system of claim 1 wherein said teacher interface allows teachers to input grades to a grade book and to define rules for grading.

9. The system of claim 1 wherein said teacher interface allows teachers to access their daily schedule.

10. The system of claim 1 wherein said teacher interface allows teachers to maintain class lists and to edit rosters of students for each class.

11. The system of claim 1 wherein said teacher interface allows teachers to create and share lesson plans

12. The system of claim 1 wherein said teacher interface allows teachers to display lessons on a smart board.

13. The system of claim 1 wherein said student interface allows students to view smart board activities created by said teachers.

14. The system of claim 1 wherein said administrator interface allows administrators to maintain class lists and teacher rosters.

15. The system of claim 2 wherein said secretary interface allows secretaries to maintain student pick-up information.

16. The system of claim 1 further comprising a public file storage area and calendar allowing the downloading of public files and the viewing of a public calendar of school activities.
